(19) United States
(12) Patent Application Publication
(10) Pub. No.: US 2026/0116080 A1
(43) Pub. Date: Apr. 30, 2026

(54) Ink Supply System, and Method for Filling an Ink Container

(71) Applicant: Canon Production Printing Holding B.V., Venlo (NL)

(72) Inventors: Florian Hitzlsperger, Poing (DE); Ulrich Stöckle, Germering (DE)

(21) Appl. No.: 19/374,537

(22) Filed: Oct. 30, 2025

(30) Foreign Application Priority Data
Oct. 30, 2024 (DE) 10 2024 131 691.8

(51) Int. Cl. B41J 2/175

(52) U.S. Cl. CPC B41J 2/17596; B41J 2/17509; B41J 2/17523; B41J 2/17566

(57) ABSTRACT

An ink supply system is described for supplying a print bar of an inkjet printing device with ink. The ink supply system includes an ink reservoir to hold ink, as well as an intermediate container that is connected in a fluid-conducting manner with the ink reservoir via a conduit. The intermediate container is configured to buffer ink for the operation of the print bar. The ink supply system also includes a negative pressure pump that is configured to produce a negative pressure in the intermediate container so that ink is conveyed, by the negative pressure, from the ink reservoir into the intermediate container via the conduit.

### CROSS-REFERENCE TO RELATED APPLICATION

This application claims priority to German Patent Application No. 102024 131 691.8 filed October 30, 2024, the disclosure of which is hereby incorporated by reference in its entirety.

### BACKGROUND OF THE INVENTION

### Field of the Invention

The invention relates to an ink supply system for providing ink for an inkjet printing device, as well as to a method for filling an ink container of a printing device.

### Description of Related Art

An inkjet printing device for printing to a recording medium can comprise one or more print bars having respectively one or more print heads. The nozzles of the individual print heads are respectively configured to eject ink droplets in order to print dots of a print image onto the recording medium. The individual print heads of the one or more print bars are supplied with ink by an ink supply system, wherein the ink supply system typically has a respective ink reservoir for the individual print bars, from which ink is provided for the operation of the inkjet printing device. The individual ink reservoirs can be swapped out, and can be used to fill a respective, permanently installed intermediate container of the ink supply system with ink.

### SUMMARY OF THE INVENTION

The present document deals with the technical object of effecting an efficient and reliable filling of an intermediate container with ink from an ink reservoir. The object is respectively achieved by the features described herein.

According to one aspect, an ink supply system is described for supplying a print bar of an inkjet printing device with ink. The ink supply system comprises an ink reservoir to hold ink, and an intermediate container that is connected in a fluid-conducting manner with the ink reservoir via a conduit and that is configured to buffer ink for the operation of the print bar. Furthermore, the ink supply system comprises a negative pressure pump that is configured to produce a negative pressure in the intermediate container so that ink is conveyed, in particular is drawn, by the negative pressure from the ink reservoir into the intermediate container by the negative pressure via the conduit

According to a further aspect, a method is described for filling an intermediate container of an ink supply system of an inkjet printing device with ink from an ink reservoir that is connected in a fluid-conducting manner with the ink reservoir via a conduit. The method comprises the production of a negative pressure in the intermediate container so that ink is conveyed, in particular is drawn, by the negative pressure from the ink reservoir into the intermediate container via the conduit.

### BRIEF DESCRIPTION OF THE DRAWINGS

In the following, exemplary embodiments of the invention are described in detail using the schematic drawings. Thereby shown are:

FIG. 1 a block diagram of an example of an inkjet printing device;

FIG. 2 an example of an ink supply system for a print bar of an inkjet printing device;

FIG. 3a an example of an ink supply system having a negative pressure pump and having a plurality of supply sub-systems;

FIG. 3b an example of a time curve of the negative pressure upon filling an intermediate container; and

FIG. 4 a workflow diagram of an example of a method for filling an intermediate container with ink from an ink reservoir.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

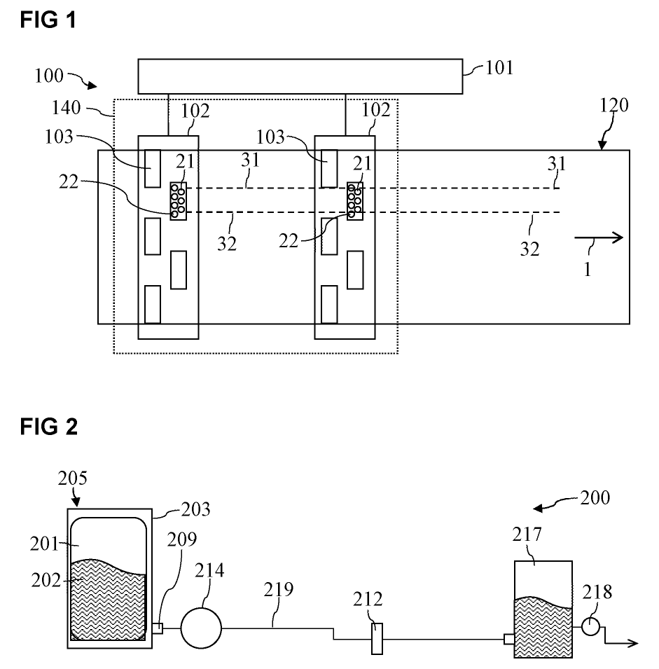

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit that is not shown in FIG. 1 and that is configured to fix a print image printed onto the recording medium 120.

A print bar 102 can comprise one or more print heads 103 that are possibly arranged side by side in a plurality of rows in order to print the dots of different columns 31, 32 of a print image onto the recording medium 120. In the example presented in FIG. 1, a print bar 102 comprises five print heads 103, wherein each print head 103 prints the dots of a group of columns 31, 32 of a print image onto the recording medium 120. The number of print heads 103 of a print bar 102 can, for example, be 5, 10, or more.

In the embodiment depicted in FIG. 1, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control device 101, for example a driving hardware and/or a controller, that is configured to drive the actuators of the individual nozzles 21, 22 of the individual print heads 103 of the print group 140 in order to apply the print image onto the recording medium 120 depending on print data. In an exemplary embodiment, the control device 101 includes processing circuitry or at least one processor that is configured to perform one or more functions and/or operations of the control device 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control device 101 includes one or more interfaces (e.g. a wired and/or wireless input and/or output interface, transceiver, or the like) that are configured to receive or output data or information. For example, the control device 101 may receive signals generated by one or more components of the printing device 100 (e.g. from a user interface of the printing device 100) and/or output control signals to one or more components of the printing device 100. In an exemplary embodiment, the control device 101 includes a memory configured to store data/information, and/or store executable code that is executable by the processing circuitry to cause the processing circuitry or at least one processor to perform the operation(s) of the control device 101.

The print group 140 of the printing device 100 thus comprises at least one print bar 102 having K nozzles 21, 22 that can be arranged in one or more print heads 103 and that can be driven with a defined line timing in order to print a respective line with K pixels or K columns 31, 32 of a print image into the recording medium 120, for example with K > 1000, said line running transverse to the transport direction 1 of said recording medium 120. In the shown example, the nozzles 21, 22 are installed immobile or fixed in the printing device 100, and the recording medium 120 is directed past the stationary nozzles 21, 22 with a defined transport velocity.

FIG. 2 shows an example of an ink supply system 200 that is designed to supply one or more print heads 103 of a print bar 102 of the printing device 100 with ink 202. The ink supply system 200 comprises an ink reservoir 205 that is designed to store ink 202. For example, the ink reservoir 205 can be designed to store and/or to hold 100 liters or more of ink 202.

The ink reservoir 205 can have an outer enclosure 203 that encloses an inner enclosure 201 of the ink reservoir 205. The inner enclosure 201 can be designed as a container, in particular a closed container, to hold ink 202. The inner enclosure 201 can, for example, be formed by a flexible bag, wherein the bag is comprised of plastic, for example. The flexible inner enclosure 201 can contract upon extraction of ink 202, so that the ink 202 can be reliably extracted, in particular pumped or drawn, completely out of the inner enclosure 201.

The (in particular flexible) inner enclosure 201 can be arranged in a preferably rigid outer enclosure 203 of the ink reservoir 205. The outer enclosure 203 can form a support structure for the inner enclosure 201. In particular, via the outer enclosure 203 it can be effected that the ink reservoir 205 can be set down in a stable manner, for example on a table or on a floor or in a compartment. The outer enclosure 203 can, for example, be designed as a preferably cubic carton, in particular a cardboard box. The ink reservoir 205 can, for example, be designed as what is known as a “Bag-in-Box.”

The ink 202 can be conducted out of the ink reservoir 205, in particular out of the inner enclosure 201, via an extraction opening 209 that, for example, is arranged at the floor of the ink reservoir 205. For this purpose, a conduit 219 can be connected to the extraction opening 209 of the ink reservoir 205. For this purpose, the extraction opening 209 can have a coupling to which the conduit 219 can be coupled in a releasable manner. A pump 214 that is designed to pump ink 202 out of the ink reservoir 205 can also be arranged at the conduit 219.

The ink 202 extracted from the ink reservoir 205 can be conducted via the conduit 219 to an intermediate container 217, wherein the ink 202 can be pumped out of the intermediate container 217, using an additional pump 218, to the one or more print heads 103 of the print bar 102. A filter unit 212 can be arranged at the conduit 219, which filter unit 212 is designed to filter the ink 202 extracted from the ink reservoir 205 in order to filter contaminants and/or sediments out of said ink 202. It can thus be reliably avoided that the nozzles 21, 22 of the one or more print heads 103 of the print bar 102 clog due to contaminated ink 202.

It is typically desirable to transfer, optimally completely transfer, the ink 202 from the ink reservoir 205 into the intermediate container 217. This can lead to the situation – in particular when the ink reservoir 205, in particular the inner enclosure 201 of the ink reservoir 205, is nearly empty – that air is also pumped together with the ink 202 into the intermediate container 217, whereby the print quality of the print bar 102 can be negatively affected. The pump 214 can also be negatively affected by the pumping of air.

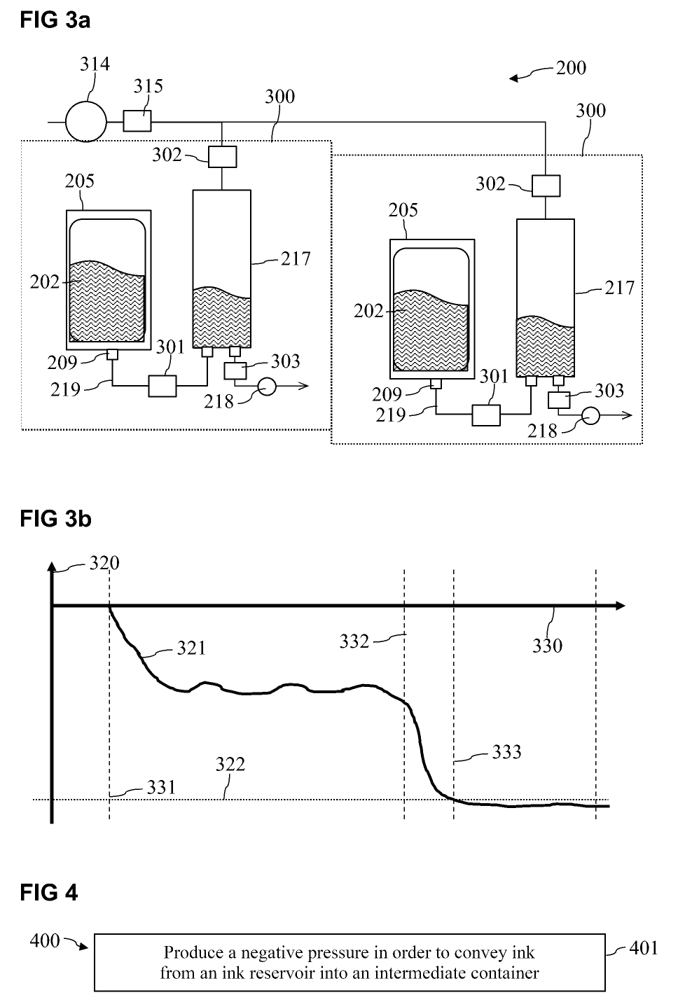

FIG. 3a shows an ink supply system 200 that, in the depicted example, has Q supply sub-systems 300 for Q different print bars 102 of the printing device 100, with Q ≥ 1. The Q supply sub-systems 300 can respectively provide different ink 202, for example inks 202 with different colors. A supply sub-system 300 respectively has an intermediate container 202 that is connected in a fluid-conducting manner with an ink reservoir 205 via a conduit 219. The ink 202 can be conveyed, in particular pumped, from the intermediate container 217 to the respective print bar 102.

The ink supply system 200 comprises a negative pressure pump 314, in particular a vacuum pump, that is configured to produce a respective physical negative pressure in the individual intermediate containers 217 of the Q supply sub-systems 300. One negative pressure pump 314 can thereby possibly be used in common for the Q different intermediate containers 217. The negative pressure pump 314 can be used to sequentially or simultaneously produce a respective negative pressure in the Q intermediate containers 217 in order to fill the respective intermediate container 217 with ink 202 from the respective ink reservoir 205.

The ink supply system 200 can comprise a pressure sensor 315 that is configured to register measured values with regard to the negative pressure produced by the negative pressure pump 314.

A supply sub-system 300 can have a respective first valve 301, in particular a reservoir valve, that is arranged at the conduit 219 between the ink reservoir 205 and the intermediate container 217 of the supply sub-system 300. Furthermore, the supply sub-system 300 can have a second valve 302, in particular a negative pressure valve, that is arranged between the intermediate container 217 and the negative pressure pump 314. The supply sub-system 300 can also have a third valve 303, in particular a supply valve, that is arranged between the intermediate container 217 and the print bar 102 supplied by the supply sub-system 300.

In order to convey ink 202 from the ink reservoir 205 of a supply sub-system 300 into the intermediate container 217 of the supply sub-system 300, the first valve 301 and the second valve 302 of the supply sub-system 300 can be opened and the third valve 303 of the supply sub-system 300 can be closed. The negative pressure pump 314 is operated in order to produce a negative pressure in the intermediate container 217, whereby ink 202 is drawn from the ink reservoir 205 into the intermediate container 217 via the conduit 219. The quantity of ink 202 that is thereby conveyed into the intermediate container 217 can depend on one or more parameters, wherein the one or more parameters comprise

the duration for which the negative pressure is produced, and/or for which the first valve 301 and/or the second valve 302 are opened;

the value of the negative pressure; and/or

the opening degree and/or the opening cross section of the first valve 301.

The filling of the intermediate container 217 can be ended by closing the first valve 301 and/or the second valve 302. By opening the third valve 303, it can also be enabled that ink 202 is conveyed from the intermediate container 217 to the print bar 102.

The individual intermediate containers 217 of the Q supply sub-systems 300 can be filled with ink 202 accordingly. It can thereby be effected that only the second valve 302 of a single supply sub-system 300 is ever opened while the second valves 302 of the Q-1 other supply sub-systems 300 are closed.

FIG. 3b shows an example of a time curve 321 of the negative pressure 320 in the intermediate container 217 of a supply sub-system 300 as a function of time 330. The negative pressure 320 is produced and/or the second valve 302 is opened as of a first point in time 331. The negative pressure 320 in the intermediate container 217 decreases as a result of this, which leads to ink 202 being conveyed, in particular drawn, from the ink reservoir 205 into the intermediate container 217. The value of the negative pressure 320 thereby remains essentially constant if the discharge of the negative pressure pump 314, for example the rotational speed of the negative pressure pump 314, remains unchanged.

As of a second point in time 332, the negative pressure 320 drops and, at a third point in time 333, reaches a negative pressure threshold 322. The dropping of the negative pressure 320 is an indicator that the ink reservoir 205, in particular the inner enclosure 201 of the ink 205, is nearly empty. If it is detected that the negative pressure 320 reaches or falls below the predefined negative pressure threshold 322, it can be determined that the ink reservoir 205 has reached a lower fill level, and in particular is empty. The dropping of the negative pressure 320 can be detected on the basis of the measured values of the pressure sensor 315. The dropping of the negative pressure 320 typically leads to a rise in the electrical power consumed by the negative pressure pump 314. Alternatively or additionally, the electrical power of the negative pressure pump 314 can thus be used as an indicator that the ink reservoir 205 has reached the lower fill level.

It is noted that, in this document, a negative pressure 320 typically has a negative value. The dropping of the negative pressure 320 typically corresponds to a rise in the amount of the value of the negative pressure 320.

In general, the (control) device 101 of the printing device 100 and/or of the ink supply system 200 can be configured to determine negative pressure information with regard to the value of the negative pressure 320 in an intermediate container 217 of the ink supply system 200. The negative pressure information can be determined on the basis of the measured values of a pressure sensor 315 and/or on the basis of the electrical power consumed by the negative pressure pump 214. Whether the ink reservoir 205 from which the intermediate container 217 is filled is empty or not can be determined on the basis of the negative pressure information. If it is detected that the ink reservoir 205 is empty, the filling of the intermediate container 217 can be ended, for example by closing the first valve 301 and/or the second valve 302. A notification to the effect that the ink reservoir 205 is to be exchanged can also be output via a user interface of the printing device 100 and/or of the ink supply system 200.

Via the measures described in this document, it can be reliably avoided that air penetrates into the intermediate container 217 of a supply sub-system 300, and/or it can be effected that the ink reservoir 205 of the supply sub-system 300 is optimally completely emptied. This can be effected in that a negative pressure pump 314 is used, possibly a single negative pressure pump 314, via which a negative pressure 320 is generated in order to extract ink 202 from the inner enclosure 201 of the ink reservoir 205 and convey said ink 202 into the intermediate container 217. The third valve 303 to the print bar 102 is thereby closed while the first valve 301 to the intermediate container 217 is opened.

The negative pressure pump 314 can be operated until the intermediate container 217 has a sufficiently high fill level. The negative pressure pump 314 can be used simultaneously or sequentially for Q different intermediate containers 217.

If the desired fill level of an intermediate container 217 is reached, the second valve 302 to the negative pressure pump 314 and the first valve 301 to the intermediate container 205 can be closed. The third valve 303 to the print bar 102 can also be opened.

The detection that the ink reservoir 205 is empty can be effected using the negative pressure pump 314. If the ink 202 is conveyed to the intermediate container 217 and the value of the negative pressure 320 thereby reaches or falls below a defined negative pressure threshold 322, it can be concluded from this that the ink reservoir 205 is empty. Alternatively or additionally, an empty ink reservoir 205 can be detected using a measurement of the power consumption of the negative pressure pump 214.

FIG. 4 shows a workflow diagram of a method 400 (possibly a computer-implemented method 400) for filling an intermediate container 217 of an ink supply system 200 of an inkjet printing device 100 with ink 202 from an ink reservoir 205, wherein the ink reservoir 205 is connected in a fluid-conducting manner with the intermediate container 217 via a conduit 219. The ink reservoir 205 can be exchangeable. For example, the ink supply system 200 can have a compartment at which the ink reservoir 205 can be arranged by a user. The ink reservoir 205 can also have, at the inlet opening 209, a coupling to which the conduit 219 can be connected so as to be detachable. The inlet opening 209 of the ink reservoir 205 can have a hose coupling, for example, possibly with a valve. On the other hand, the intermediate container 217 can be permanently installed in the ink supply system 200. The method 400 can be executed by a control device 101 of the ink supply system 200 and/or of the printing device 100.

The method 400 comprises the production 401 of a negative pressure 320 in the intermediate container 217 so that ink 202 is conveyed, by the negative pressure 320, from the ink reservoir 205 into the intermediate container 217 via the conduit 219. The negative pressure 320 typically has a value that is less than the value of the ambient pressure, wherein the ambient pressure can have a value that is essentially zero. The negative pressure 320 can be produced by a negative pressure pump 324, in particular by a vacuum pump, of the ink supply system 200. The ink 202 can be especially reliably and completely conducted from the ink reservoir 205 into the intermediate container 217 via the production 401 of a negative pressure 320.

Furthermore, in this document an ink supply system 200 is described for supplying at least one print bar 102 of an inkjet printing device 100 with ink 202. The ink supply system 200 can have one or more supply sub-systems 300 for accordingly one or more print bars 102 of the printing device 100. The individual supply sub-systems 300 can respectively be designed to provide a defined ink 202, for example to provide ink 202 with a defined color. Different types of ink 202 can thus be provided by the different supply sub-systems 300. The different types of ink 202 can be provided in different ink reservoirs 205.

The ink supply system 200 comprises, in particular as part of a supply sub-system 300, an ink reservoir 205 to hold ink 202. The ink reservoir 205 can have a flexible inner enclosure 201 in which the ink 202 is stored. The ink reservoir 205 can be designed as a separate unit, for example as a separate box, that can be arranged comfortably by a user in a compartment of the ink supply system 200 and be connected, via a coupling, with a conduit 219 so as to be detachable.

The ink supply system 200 also comprises an intermediate container 217, for example as part of a supply sub-system 300, which intermediate container 217 is connected in a fluid- conducting manner with the ink reservoir 205 via a conduit 219, and which is configured to buffer ink 202 for the operation of the print bar 102. The intermediate container 217 can be permanently installed in the ink supply system 200. The intermediate container 217 can be designed as a buffer storage via which a continuous supply of the print bar 102 with ink 202 is ensured for a defined buffer time period.

Furthermore, the ink supply system 200 comprises a negative pressure pump 314 that is configured to produce a negative pressure 320 in the intermediate container 217 so that, due to the negative pressure 320, ink is conveyed, in particular is drawn, from the ink reservoir 205 into the intermediate container 217 via the conduit 219. The conduit 219 can be connected to the underside of the intermediate container 217, in particular to the floor, so that ink 202 is conveyed via the underside into the intermediate container 217. On the other hand, the negative pressure pump 314 is designed to convey air out of the intermediate container 217 via the opposite, top side of the intermediate container 217 in order to produce the negative pressure 320 in the intermediate container 217.

The ink supply system 200 can thus be designed such that ink 202 is drawn, and not pumped, from the ink reservoir 205 into the intermediate container 217. An air inclusion in the ink 202 arranged in the intermediate container 217 can thus be reliably avoided. A complete emptying of the ink reservoir 105 can thus also be produced in a reliable and gentle manner.

The ink supply system 200 can comprise a reservoir valve 301, in particular as part of a supply sub-system 300, which reservoir valve 301 is designed to enable or prevent the flow of ink 202 from the ink reservoir 205 to the intermediate container 217 via the conduit 219. The reservoir valve 301 can be arranged at the conduit 219 to the intermediate container 217. Furthermore, the ink supply system 200 can comprise a supply valve 303, in particular as part of a supply sub-system 300, which supply valve 303 is designed to enable or to prevent the flow of ink 202 from the intermediate container 217 to the print bar 102. The supply valve 303 can be arranged at a conduit from the intermediate container 217 to the print bar 102.

For the filling of the intermediate container 217 with ink 202, the control device 101 of the ink supply system 200 and/or of the printing device 100 can be configured to effect that the reservoir valve 301 is opened and the supply valve 303 is closed. Furthermore, for supplying the print bar 102 with ink, the control device 101 can be configured to effect that the reservoir valve 301 is closed and the supply valve 303 is opened. An especially reliable filling of the intermediate container 217 with ink 202 can thus be effected in order to ensure a reliable supplying of the print bar 102 with ink 202 in the long term.

The control device 101 can be configured to effect that a negative pressure 320 is produced in the intermediate container 217 at a starting point in time 331, so that ink 202 is conveyed from the ink reservoir 205 into the intermediate container 217 as of the starting point in time 331. For this purpose, it can be effected that the negative pressure valve 302 arranged between the negative pressure pump 314 and the intermediate container 217 is opened at the starting point in time 331.

Alternatively or additionally, it can be effected that the operation of the negative pressure pump 314 is started at the starting point in time 331.

The control device 101 can also be configured to determine, at a subsequent ending point in time, that the intermediate container 217 has a determined target fill level of ink 202. For example, the control device 101 can be configured to determine one or more parameters with regard to the feed rate with which ink 202 is conveyed from the ink reservoir 205 into the intermediate container 217 via the conduit 219. Examples of parameters are

negative pressure information with regard to the value of the negative pressure 320 in the intermediate container 317;

the opening cross section of the conduit 219, in particular of the reservoir valve 301, between the ink reservoir 205 and the intermediate container 217; and/or

a flow property, for example the viscosity, of the ink 202 in the ink reservoir 205.

On the basis of the one or more parameters, it can then be precisely determined that the intermediate container 217 has the target fill level of ink 202.

Furthermore, the control device 101 can be configured to effect, in reaction to the determination that the intermediate container 217 has the target fill level of ink 202, that ink 202 is no longer conveyed from the ink reservoir 205 into the intermediate container 217. An especially reliable filling of the intermediate container 217 can thus be efficiently effected.

The control device 101 can be configured to determine negative pressure information with regard to the value of the negative pressure 320 in the intermediate container 317. The negative pressure information can be determined on the basis of measured values of a pressure sensor 315 of the ink supply system 200, wherein the pressure sensor 315 is configured to register measured values with regard to the value of the negative pressure 320 in the intermediate container 317. Alternatively or additionally, the negative pressure information can be determined on the basis of the electrical power that the negative pressure pump 314 consumes to generate the negative pressure 320.

The control device 101 can also be configured to determine, on the basis of the negative pressure information, that the ink reservoir 205 has reached or fallen below a lower fill level. The lower fill level can, for example, correspond to a fill level of 10% or less of the total volume of the completely filled ink reservoir 205.

A measure with regard to the ink reservoir 205 can be effected in reaction to the determination that the ink reservoir 205 has reached or fallen below a lower fill level. Examples of measures are
effecting that ink 202 is no longer conveyed from the ink reservoir 205 into the intermediate container 217. For example, this can be effected in that the reservoir valve 301 is closed; and/or
outputting a notification via the user interface of the ink supply system 200 and/or of the printing device 100, to the effect that the ink reservoir 205 has reached or fallen below the lower fill level. The user can in particular be notified that the ink reservoir 205 should be exchanged.

An especially reliable and comfortable filling of the intermediate container 217 with ink 202 can be effected via the monitoring of the fill level of the ink reservoir 205.

The printing device 100 can have Q different print bars 102, with Q > 1. The ink supply system 200 can comprise Q different supply sub-systems 300 for providing ink 202 for the corresponding Q print bars 102, wherein the individual supply sub-systems 300 respectively comprise an ink reservoir 205 and an intermediate container 217 that are respectively connected with one another in a fluid-conducting manner via a conduit 219. The negative pressure pump 314 can be designed to effect a respective negative pressure 320 in the intermediate containers 217 of the Q supply sub-systems 300, in order to convey ink 202 from the respective ink reservoir 205 into the respective intermediate container 217 via the respective conduit 219. A single negative pressure pump 314 can thus be efficiently used in order to effect the filling of Q different intermediate containers 217.

The Q supply sub-systems 300 can respectively comprise a negative pressure valve 302 that is designed to decouple the negative pressure pump 314 from the intermediate container 217 of the respective supply sub-system 300, or to couple said negative pressure pump 314 in a fluid-conducting manner with the intermediate container 217 of the respective supply sub-system 300. The control device 101 can be configured to open the negative pressure valves 302 of the Q supply sub-systems 300 individually and exclusively of one another, in particular such that a negative pressure 320 is produced serially in the individual intermediate containers 217 of the Q supply sub-systems 300 in order to serially fill the individual intermediate containers 217 of the Q supply sub-systems 300 with ink 202. The negative pressure pump 314 can thus be used to produce the negative pressure 320 in respectively precisely one intermediate container 217 in chronologically successive time intervals. An especially reliable filling of the different intermediate containers 217 can thus be effected using a single negative pressure pump 314.

Moreover, in this document a printing device 100 is described that comprises the ink supply system 200 described in this document.

An especially efficient and robust ink supply to one or more print bars 102 of an inkjet printing device 100 can be effected via the measures described in this document.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### Reference list

1 transport direction (of the recording medium)

21, 22 nozzle

31, 32 column (of the print image)

100 printing device

101 (control) device

102 print bar

103 print head

120 recording medium

140 print group

200 ink supply system

201 inner enclosure (reservoir)

202 ink

203 outer enclosure (reservoir)

209 extraction opening

212 filter unit

214 pump

217 intermediate container

218 pump

219 conduit

300 supply sub-system

301-303 valve

314 negative pressure pump

315 pressure sensor

320 negative pressure

321 time curve of the negative pressure

322 negative pressure threshold

330 time

331-333 point in time

400

method for filling an intermediate container

401

method step

1. An ink supply system for supplying a print bar of an inkjet printing device with ink, the ink supply system comprising
an ink reservoir to hold ink;
an intermediate container connected in a fluid-conducting manner with the ink reservoir via a conduit, and configured to buffer ink for operation of the print bar; and
a negative pressure pump configured to produce a negative pressure in the intermediate container so that ink is conveyed, by the negative pressure, from the ink reservoir into the intermediate container via the conduit.

2. The ink supply system according to claim 1, further comprising
a reservoir valve configured to enable or prevent the flow of ink from the ink reservoir to the intermediate container via the conduit;
a supply valve configured to enable or prevent the flow of ink from the intermediate container to the print bar; and
a control device that, for filling of the intermediate container with ink, is configured to control the reservoir valve to be opened and the supply valve to be closed.

3. The ink supply system according to claim 1, further comprising a control device configured
to effect that a negative pressure is produced in the intermediate container at a starting point in time, so that ink is conveyed from the ink reservoir into the intermediate container as of the starting point in time;
to determine, at a subsequent ending point in time, that the intermediate container has a target fill level of ink; and
to effect, in reaction to the determination, that ink is no longer conveyed from the ink reservoir into the intermediate container.

4. The ink supply system according to claim 3, wherein the control device is further configured
to determine one or more parameters with regard to a delivery rate with which ink is conveyed from the ink reservoir into the intermediate container via the conduit; wherein the one or more parameters comprise at least one of
negative pressure information with regard to a value of the negative pressure in the intermediate container;
an opening cross section of the conduit between the ink reservoir and the intermediate container; or
a flow property of the ink in the ink reservoir; and
to determine, based on the one or more parameters, that the intermediate container has the target fill level of ink.

5. The ink supply system according to claim 1, further comprising a control device that is configured
to determine negative pressure information with regard to a value of the negative pressure in the intermediate container;
to determine, based on the negative pressure information, that the ink reservoir has reached or fallen below a lower fill level; and
in reaction to the determination, to effect a measure with regard to the ink reservoir.

6. The ink supply system according to claim 5, wherein the measure comprises
effecting that ink is no longer conveyed from the ink reservoir into the intermediate container; and
outputting a notification, via a user interface, to indicate that the ink reservoir has reached or fallen below the lower fill level.

7. The ink supply system according to claim 5, wherein the control device is configured to determine the negative pressure information based on at least one of:
measured values of a pressure sensor of the ink supply system; or
an electrical power that the negative pressure pump consumes to generate the negative pressure.

8. The ink supply system according to claim 1, wherein
the conduit is connected to an underside of the intermediate container so that ink is conveyed via the underside into the intermediate container.

9. The ink supply system according to claim 1, wherein
the negative pressure pump is configured to convey air out from the intermediate container via a top side of the intermediate container in order to produce the negative pressure.

10. The ink supply system according to claim 1, wherein
the printing device has Q different print bars, with Q > 1;
the ink supply system comprises Q different supply sub-systems for providing ink for the corresponding Q print bars;
the individual supply sub-systems respectively comprise an ink reservoir and an intermediate container that are respectively connected with one another in a fluid-conducting manner via a conduit; and
the negative pressure pump is configured to effect a respective negative pressure in the intermediate containers of the Q supply sub-systems, in order to convey ink from the respective ink reservoir into the respective intermediate container via the respective conduit.

11. The ink supply system according to claim 8, wherein
the Q supply sub-systems respectively comprise a negative pressure valve that is configured to decouple the negative pressure pump from the intermediate container of the respective supply sub-system, or to couple the negative pressure pump in a fluid-conducting manner with the intermediate container of the respective supply sub-system; and
the ink supply system comprises a control device that is configured to open the negative pressure valves of the Q supply sub-systems individually and exclusively of one another so that a negative pressure is produced serially in the individual intermediate containers of the Q supply sub-systems, in order to serially fill the individual intermediate containers of the Q supply sub-systems with ink .

12. A method for filling an intermediate container of an ink supply system of an inkjet printing device with ink from an intermediate container that is connected in a fluid-conducting manner with the intermediate container via a conduit the method comprising
producing a negative pressure in the intermediate container so that ink is conveyed, by the negative pressure, from the ink reservoir into the intermediate container via the conduit.
